(19) United States
(12) Patent Application Publication
(10) Pub. No.: US 2006/0174287 A1
(43) Pub. Date: Aug. 3, 2006

(54) Data transmitter, program product, and data transmission system

(76) Inventor: Shigeru Maeda, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/341,958

(22) Filed: Jan. 27, 2006

(30) Foreign Application Priority Data
Jan. 31, 2005 (JP) P2005-024453

(51) Int. Cl. H04N 7/173; H04N 7/18

(52) U.S. Cl. 725/80; 725/90; 725/113

(57) ABSTRACT

A data transmitter for executing stream-type data transmission of stream data having a predetermined data composition unit to a data receiver includes: a data supply section that supplies the stream data; a buffer for temporarily storing the stream data supplied from the data supply section; and a communication section for reading the stream data stored in the buffer and transmitting the data to the data receiver. When a data amount of the stream data supplied from the data supply section exceeds an available capacity of the buffer, the buffer retains at least untransmitted data that has not been transmitted from the communication section, of the data in the predetermined data composition unit of the data stream being transmitted from the communication section until the untransmitted data is transmitted from the communication section.

### CROSS-REFERENCE TO RELATED APPLICATIONS

This application is based upon and claims the benefit of priority from the prior Japanese Patent Application No. 2005-024453, filed on Jan. 31, 2005; the entire contents of which are incorporated herein by reference.

### BACKGROUND

1. Field

One embodiment of the invention relates to a data transmitter for transmitting stream data of moving image data, etc., a program for controlling the data transmitter, and a data transmission system for transmitting stream data of moving image data, etc.

2. Description of the Related Art

At present, data transfer of image data, audio data, etc., through various communication media such as the Internet and a LAN (Local Area Network) is briskly executed. Particularly, a stream-type transmission system is becoming pervasive with improvement of the recent network transmission speed. The stream-type transmission system is a system of reproducing reception data in parallel with transferring data from a transmitter to a reception terminal. At this time, for example, the transmitter once stores an MPEG stream created by performing MPEG compression processing of image data in a buffer and then transmits the MPEG stream as an IP (Internet Protocol) packet, and the reception terminal buffers the MPEG streams received as IP packets until the MPEG streams (IP packets) become data required for decoding, and decodes the data in sequence. As such processing is performed, the delay from reception of data to reproduce of the data in the reception terminal is lessened and reproduce almost in real time is made possible. (For example, refer to JP-A-2003-169040.)

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary drawing to show the configuration of a video communication system using a wireless TV tuner according to an embodiment of the invention;

FIG. 2 is an exemplary block diagram to show the configurations of the wireless TV tuner and a PC for receiving data from the wireless TV tuner in the embodiment;

FIGS. 3A and 3B are drawings to show examples of content information and media information that a content information management section of the wireless TV tuner has in the embodiment;

FIG. 4 is an exemplary flowchart to show a processing flow of a program before the wireless TV tuner starts transmitting content data in the embodiment;

FIG. 5 is an exemplary drawing to show the data structure of MPEG2-PS to be encoded by an encoder of the wireless TV tuner in the embodiment;

FIGS. 6A and 6B are drawings to show a configuration example of a stream buffer of the wireless TV tuner in the embodiment;

FIG. 7 is an exemplary flowchart to show a flow of data write control into the stream buffer by a program for controlling the wireless TV tuner in the embodiment;

FIG. 8 is an exemplary flowchart to show a processing flow for a communication section involved in transmission processing by the program for controlling the wireless TV tuner in the embodiment;

FIG. 9 is an exemplary flowchart to describe a processing flow after discontinuation resumption of communications with the PC, such for recovering network traffic, by the program for controlling the wireless TV tuner in the embodiment;

FIG. 10 is an exemplary drawing to describe untransmitted data stored in a data-being-transmitted storage area of the wireless TV tuner in the embodiment;

FIG. 11 is an exemplary drawing to show the data structure of PCP of DTCP-IP provided by the encoder of the wireless TV tuner in the embodiment; and

FIG. 12 is a drawing to show a configuration example of a stream buffer of the wireless TV tuner in the embodiment.

### DETAILED DESCRIPTION

Various embodiments according to the invention will be described hereinafter with reference to the accompanying drawings.

A data transmitter and a program according to an embodiment of the invention will be described with reference to the accompanying drawings.

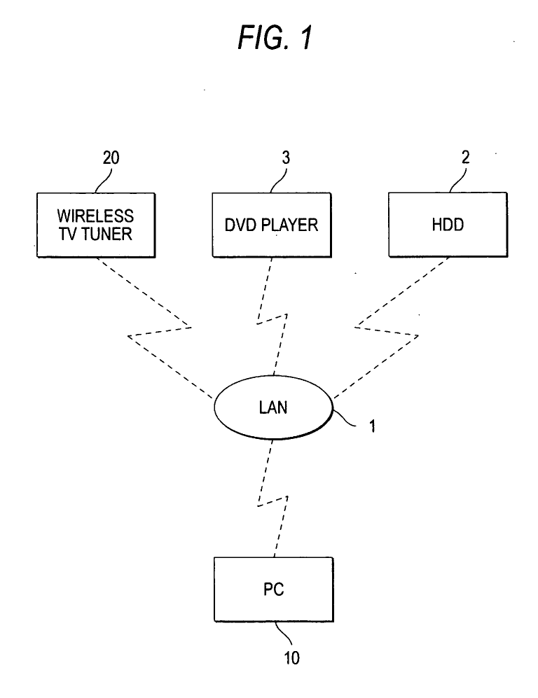

FIG. 1 is a drawing to show the configuration of a video communication system using a wireless TV tuner (data transmitter) according to an embodiment of the invention. As shown in FIG. 1, the video communication system is made up of a LAN 1, a PC (Personal Computer) 10, a wireless TV tuner 20 for transmitting TV tuner video data to the PC 10, an HDD (Hard Disk Drive) 2 for storing the video data to be viewed on the PC 10, and a DVD player 3 for playing back a DVD (Digital Versatile Disk) for the user to view on the PC 10. That is, the PC 10 enables the user to view video from the wireless TV tuner 20, video from the HDD 2, and video from the DVD player 3 through the LAN 1. Now, the wireless TV tuner 20 and the PC 10 will be described.

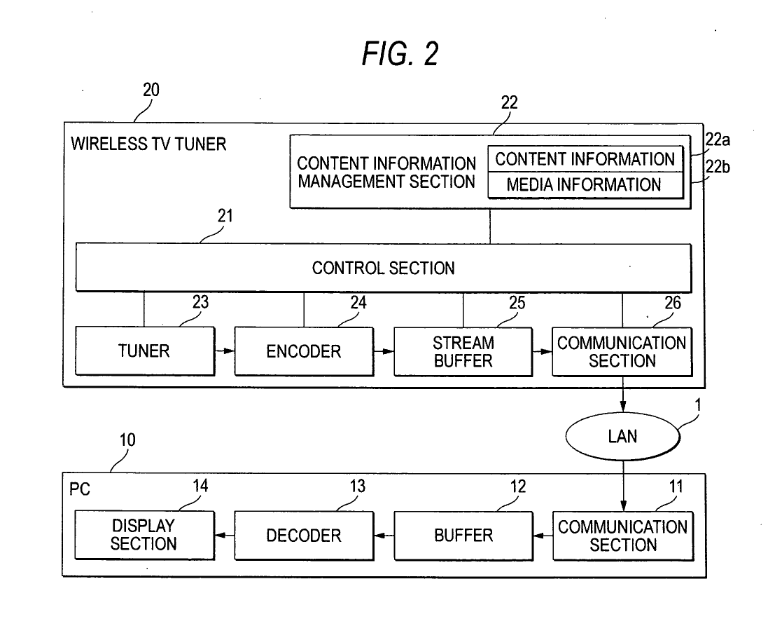

FIG. 2 is a block diagram to show the configurations of the wireless TV tuner 20 and the PC 10. The wireless TV tuner 20 and the PC 10 are connected by the LAN 1 as described above.

The wireless TV tuner 20 has a control section 21, a content information management section 22 (data composition unit determination section), a tuner 23 for receiving terrestrial analog broadcasts, BS digital broadcasts, and terrestrial digital broadcasts, an encoder 24 (data supply section) for encoding the received analog video data, a stream buffer 25 for temporarily storing the data supplied from the encoder 24, and a communication section 26 for transmitting data to the PC 10. The content information management section 22, the tuner 23, the encoder 24, the stream buffer 25, and the communication section 26 are connected to the control section 21.

The control section 21 is made up of a CPU (Central Processing Unit) and memory for controlling the whole operation of the wireless TV tuner 20.

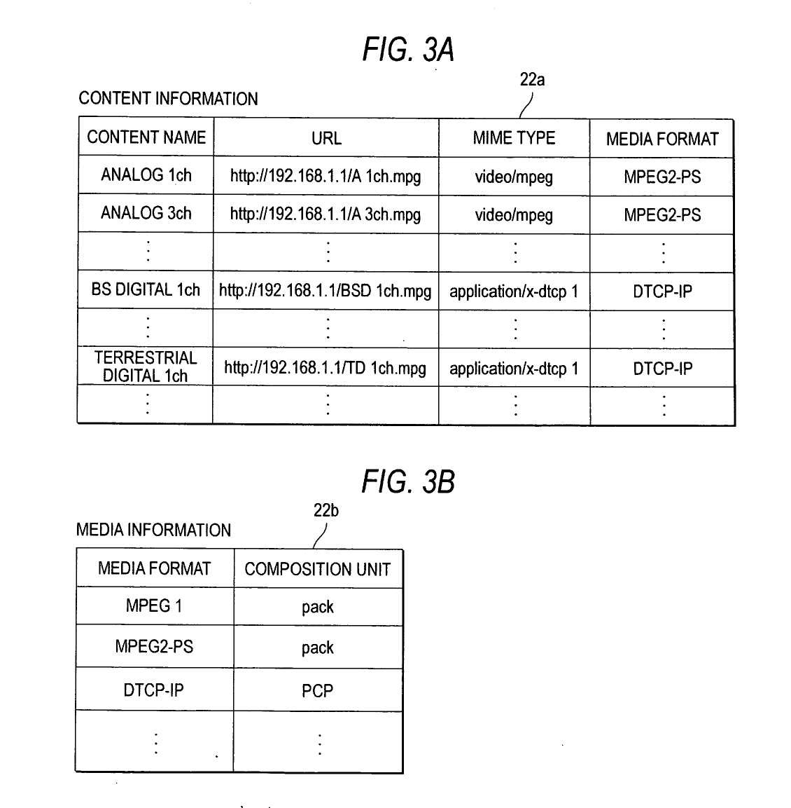

The content information management section 22 has content information 22a and media information 22b and manages information concerning data transmitted from the communication section 26 to the PC 10. FIGS. 3A and 3B show examples of the content information 22a and the media information 22b.

FIG. 3A is a drawing to show an example of the content information that the content information management section 22 has. The content information has information concerning the content name, URL (Uniform Resource Locator), MIME (Multipurpose Internet Mail Extension) TYPE, and media format of content data that can be distributed from the wireless TV tuner 20. The wireless TV tuner 20 covers terrestrial analog broadcasts, BS digital broadcasts, and terrestrial digital broadcasts and thus the content information 22a stores information for the channels. The HDD 2, the DVD player 3, and the like also have such content information.

The content name is the name of content data presented to the user. In the example in FIG. 3A, the content names such as “analog 1ch” and “BS digital 1ch” are assigned. The content name can be displayed on a display section 14 of the PC 10 and the user can select content with the content name as a key.

The URL is a URL used in accessing the content data from the PC 10. For example, analog 1ch is assigned URL “http://192.168.1.1/A1ch.mpg” and BS digital 1ch is assigned URL “http://192.168.1.1/BSD1ch.mpg.”

The MIME TYPE serves as an identifier to inform the PC 10 of the media type. For example, when MIME TYPE is “video/mpeg” as in analog 1ch in FIG. 3A, it is known that the media type is MPEG; when MIME TYPE is “application/x-dtcp1” as in BS digital 1ch, it is known that the media type is DTCP-IP (Digital Transmission Contents Protection over Internet Protocol). The wireless TV tuner 20 sends MIME TYPE to the PC 10 before transmitting content data to the PC 10.

The media format defines the media format in the case of transmitting of the content data. In the example in FIG. 3A, analog broadcast of analog 1ch, etc., is encoded to MPEG2-PS and transmitting, and digital broadcast of BS digital 1ch, etc., is transmitting encapsulated to DTCP-IP.

FIG. 3B is a drawing to show an example of the media information 22b that the content information management section 22 has. The media information 22b indicates the composition unit (predetermined data composition unit) corresponding to each media format. In the example in FIG. 3B, it is seen that the composition unit of each of MPEG1 and MPEG2-PS is pack and the composition unit of DTCP is PCP (Protected Content Packets). The composition unit becomes the unit for the stream buffer 25 to manage the content data.

Referring again to FIG. 2, the tuner 23 is a tuner for receiving TV broadcast signals. The tuner 23 can receive terrestrial analog broadcasts, BS digital broadcasts, and terrestrial digital broadcasts.

The encoder 24 encodes a TV broadcast signal received in the tuner 23 to a predetermined media format. The encoder 24 encodes a terrestrial analog broadcast to MPEG2-PS and a BS digital broadcast and a terrestrial digital broadcast to DTCP-IP as described above according to the media format defined in the media information 22b that the content information management section 22 has.

The stream buffer 25 is a buffer for temporarily storing the content data provided by the encoder 24. The stream buffer 25 changes the management method depending on the media format of the content data according to the media information 22b that the content information management section 22 has. Specifically, when the media format is MPEG2-PS, the data is managed in pack units; when the media format is DTCP-IP, the data is managed in PCP units, as described later in detail.

The communication section 26 is a communication interface of the wireless TV tuner 20. The communication section 26 transmits the content data read from the stream buffer 25 to the PC 10 through the LAN 1 as an IP packet. At this time, the communication section 26 notifies the control section 21 of the data amount of the data transmitted to the PC 10.

The PC 10 is made up of a communication section 11, a buffer 12, a decoder 13, and the above-mentioned display section 14. The PC 10 also has a control section for controlling the whole operation, an operation section for the user to select content, and the like although not shown in FIG. 2.

The communication section 11 is a communication interface for receiving content data from the wireless TV tuner 20. The communication section 11 receives the content data as an IP packet and passes it to the buffer 12.

The buffer 12 temporarily stores the content data received through the communication section 11 until the content data becomes the data amount required for decoding. When the content data stored in the buffer 12 reaches the data amount required for decoding, the decoder 13 decodes the data in sequence. For example, when the media format of the content data is MPEG2-PS, the decoder 13 generally decodes the data in pack units; when the media format is DTCP-IP, the decoder 13 decodes the data in PCP units. Thus, when the data stored in the buffer 12 reaches the composition unit, the decoder 13 decodes the data in sequence. The display section 14 displays video provided as the decoder 13 decodes the content data.

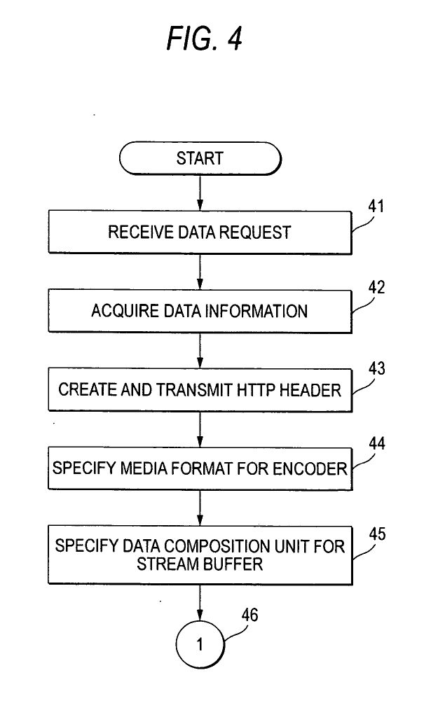

Next, a flow of a program executed by the control section 21 when content data is transmitted from the wireless TV tuner 20 to the PC 10 will be described by taking transmission of analog 1ch as an example. FIG. 4 is a flowchart to show a processing flow of the program before the wireless TV tuner 20 starts transmitting analog 1ch to the PC 10.

To begin with, the wireless TV tuner 20 receives a data request from the PC 10 at the communication section 26 (step 41). At this time, each content is specified by the URL from the PC 10. The control section 21 can determine each content by referencing the URL accessed by the PC 10 and the content information 22a that the content information management section 22 has. More specifically, in the example in FIG. 3A, when the URL “http://192.168.1.1/A1ch.mpg” is accessed by the PC 10, the control section 21 can know that it should transmit analog 1ch by referencing the content information 22a.

Next, the control section 21 acquires MIME TYPE, media format, and composition unit information required for transmitting the content data (step 42). When analog 1ch is applied, the control section 21 can know that MIME TYPE for transmitting the content data using HTTP (Hypertext Transfer Protocol) is “video/mpeg” and that the media format to encode to is MPEG2-PS by referencing the content information 22a. Further, the control section 21 can know that the composition unit of MPEG2-PS is pack by referencing the media information 22b.

The program generates an HTTP header containing MIME TYPE (here, “video/mpeg”) based on the acquired information and transmits the HTTP header to the data receiver from the communication section 26 (step 43). As the PC 10 receives the HTTP header, it can know that the media format of the content data to be received is MPEG, and can perform processing accordingly.

Further, the control section 21 specifies the media format to encode to for the encoder 24 (step 44). When analog 1ch is applied, the encoder 24 encodes the terrestrial analog broadcast received from the TV tuner 23 to MPEG2-PS.

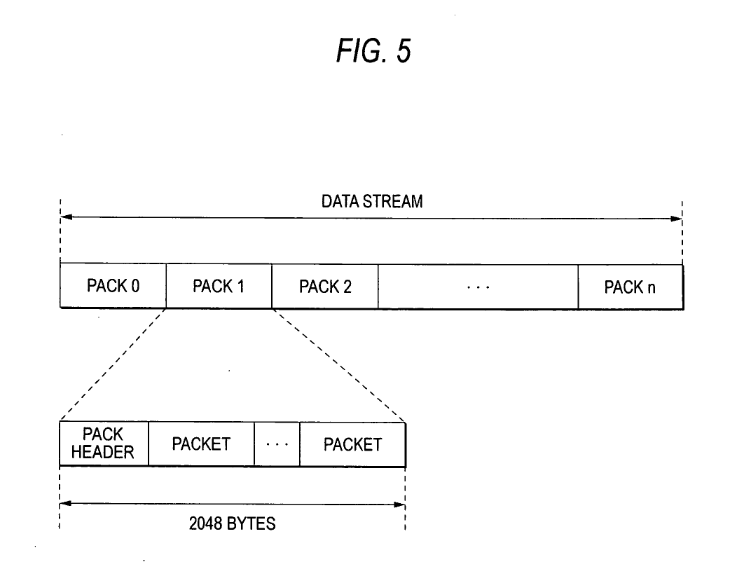

FIG. 5 is a drawing to show the data structure of MPEG2-PS to encode to in the encoder 24. As shown in FIG. 5, the data stream of MPEG2-PS is made up of packs each of a fixed length of 2048 bytes. Further, each pack is made up of a pack header and a plurality of packets.

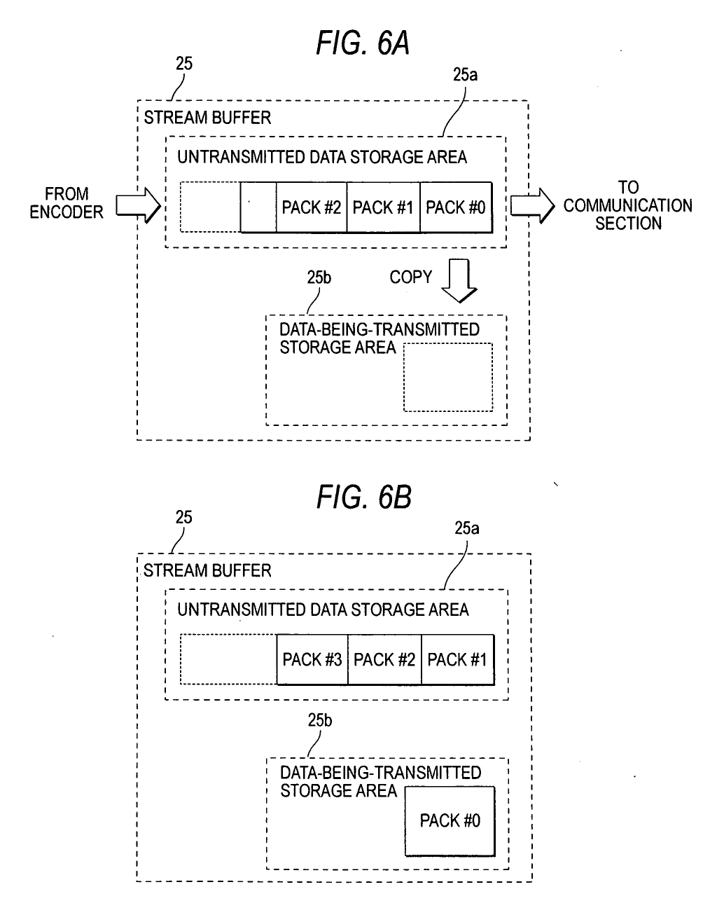

The control section 21 also notifies the stream buffer 25 of the data composition unit (step 45). When the media format is MPEG2-PS, the data composition unit is pack. FIGS. 6A and 6B are drawings to show a configuration example of the stream buffer 25 for managing data in pack units. To manage data in pack units, the stream buffer 25 provides an untransmitted data storage area 25a and a data-being-transmitted storage area 25b.

As shown in FIG. 6A, the data supplied from the encoder 24 is stored in the untransmitted data storage area 25a in sequence. The data supplied from the encoder 24 need not necessarily be in pack units. To transmit the data, the stream buffer 25 passes the data to the communication section 26 in pack units in sequence. Since each pack is of fixed length as described above, the stream buffer 25 can recognize each pack by separating the data 2048 bytes each from the top of the data. A copy of the pack passed to the communication section 26 is created in the data-being-transmitted storage area 25b. That is, as shown in FIG. 6B, for example, when pack #0 is transmitted from the communication section 26, the data in pack #0 is retained in the data-being-transmitted storage area 25b.

After such processing is performed, transmitting the content data of analog 1ch to the PC 10 is started (step 46).

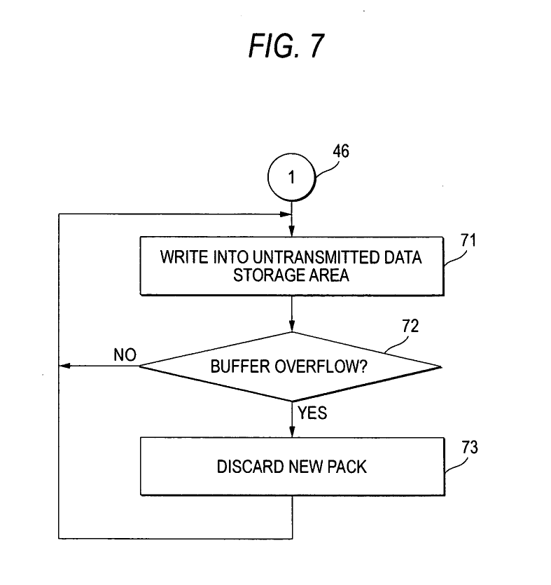

Next, write control into the stream buffer 25 while the content data of analog 1ch is being transmitted will be discussed. FIG. 7 is a flowchart to show a flow of data write control into the stream buffer 25 by the program executed in the control section 21 for transmitting the content data of analog 1ch from the wireless TV tuner 20 to the PC 10.

When transmitting the content data of analog 1ch to the PC 10 is started (step 46), the encoder 24 encodes the analog signal of analog 1ch received from the tuner 23 to the MPEG-PS format in sequence. The control section 21 writes the data provided by the encoder 24 into the untransmitted data storage area 25a in sequence (step 71). At this time, the control section 21 determines whether or not a buffer overflow occurs, namely, whether or not the data can be written into the untransmitted data storage area 25a (step 72). When a buffer overflow occurs (YES at step 72), the control section 21 discards one pack (namely, 2048 bytes) of the data supplied from the encoder 24 (step 73). After the control section 21 discards the data or when a buffer overflow does not occur (NO at step 72), the control section 21 further writes new data (step 71).

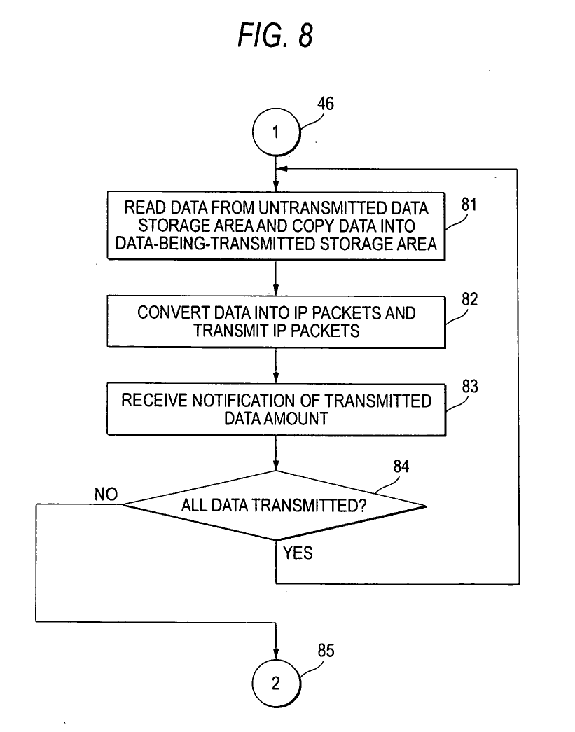

Subsequently, a processing flow for the communication section 26 for transmitting the data of analog 1ch from the communication section 26 to the PC 10 will be discussed. FIG. 8 is a flowchart to show a processing flow for the communication section 26 by the program executed in the control section 21 for transmitting the content data of analog 1ch from the wireless TV tuner 20 to the PC 10.

To begin with, the control section 21 reads the next data to be transmitted in pack units from the untransmitted data storage area 25a and also creates a copy of the data in the data-being-transmitted storage area 25b (step 81). At this time, the area in the untransmitted data storage area 25a storing the read data in the pack unit becomes available and new data from the encoder 24 can be written thereinto.

Next, the control section 21 converts the read data into IP packets and causes the communication section 26 to transmit the IP packets through the LAN 1 to the PC 10 in sequence (step 82). After the data is transmitted, the control section 21 is notified of the transmitted data amount from the communication section 26 (step 83). The control section 21 determines whether or not the data amount matches the read data amount at step 81, namely, whether or not the transmitted data amount is 2048 bytes (step 84). When the data amount matches the read data amount (YES at step 84), the control section 21 goes to step 81 for performing transmission processing of he next pack.

When the read data amount at step 81 does not match the data amount reported from the communication section 26 (NO at step 84), the control section 21 determines that the communications between the wireless TV tuner 20 and the PC 10 are discontinued, and goes to step 85 for performing processing after discontinuation.

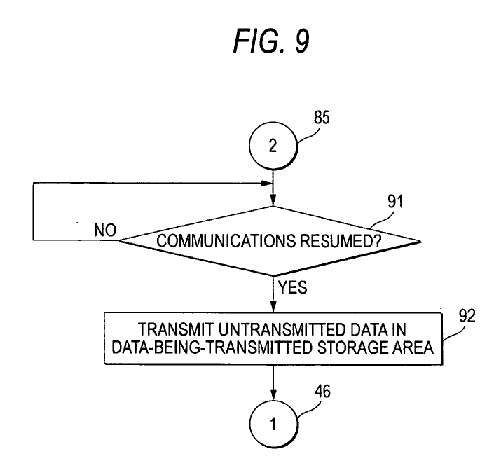

Processing of the program executed in the control section 21 after discontinuation of communications with the PC 10 will be discussed with reference to FIG. 9. FIG. 9 is a flowchart to describe a processing flow of the program executed in the control section 21 after discontinuation of communications with the PC 10.

When the communications are discontinued (step 85), the control section 21 determines whether or not communications between the PC 10 and the communication section 26 are resumed (step 91). When communications are not resumed (NO at step 91), the control section 21 waits for resumption of communications. When communications are resumed (YES at step 91), the control section 21 transmits untransmitted data of the data stored in the data-being-transmitted storage area 25b from the communication section 26 to the PC 10 (step 92).

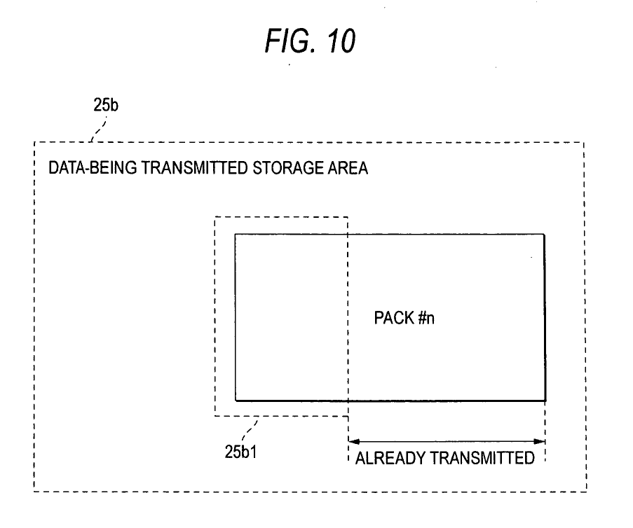

FIG. 10 is a drawing to describe untransmitted data in the data-being-transmitted storage area 25b in resuming communications. The data amount of the data transmitted from the communication section 26 to the PC 10 can be acquired according to step 83 in FIG. 8. Thus, the control section 21 determines that the portion provided by excluding the already transmitted data amount from the data stored in the data-being-transmitted storage area 25b is untransmitted data 25b1 and passes the untransmitted data 25b1 to the communication section 26 for transmission to the PC 10. After transmitting the untransmitted data 25b1, the control section 21 makes a transition to usual data transfer processing (step 46).

Subsequently, the case where the content data sent from the wireless TV tuner 20 to the PC 10 is BS digital 1ch will be discussed. When the content data is BS digital 1ch, data is transferred according to DTCP-IP. DTCP-IP is a digital rights management technique on the network having features for machine authentication and key exchange processing, CCI (Copy Control Information) setting processing, content encryption processing, exclusion of unauthorized machines, etc., and is a standard aiming at a home AV network, etc. In DTCP-IP, content data is encrypted using a cipher key for transmission. In the description to follow, it is assumed that the wireless TV tuner 20 and the PC 10 previously have cipher key.

To transmit BS digital 1ch, the processing flow involved in connection in FIG. 4 is almost similar. However, as the content data information acquired at step 42, the media format is DTCP-IP as seen in the content information 22a and the data composition unit of DTCP-IP is PCP as seen in the media information 22b.

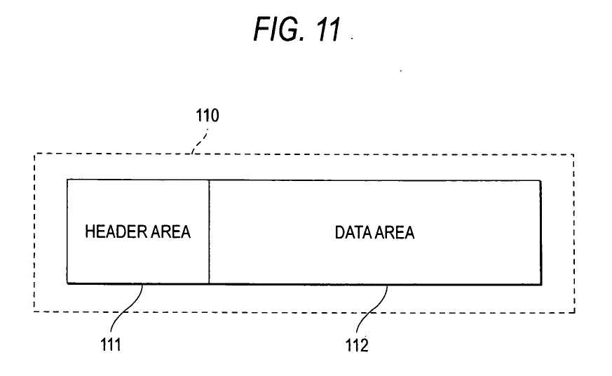

Thus, the control section 21 specifies the media format DTCP-IP for the encoder 24 at step 44, the encoder 24 encodes the data of BS digital 1ch received from the tuner 23 (broadcast in MPEG2-TS format) to the PCP format. FIG. 11 is a drawing to show an example of the data structure of PCP. PCP 110 is made up of a header area 111 and a data area 112, and each data is encrypted and is stored in the data area 112 of PCP. The data size of the PCP 110 is not fixed unlike the pack. The data length of the PCP 110 is described in the header area 111, and the decoder knows the data length of the PCP 110 by reading the header area 111.

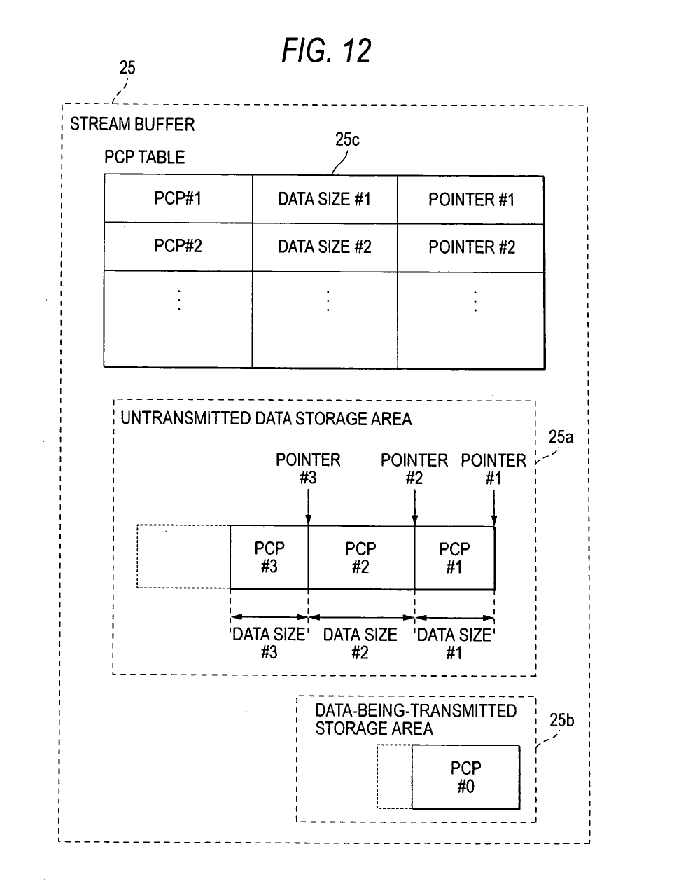

As the control section 21 specifies the data composition unit PCP at step 45, the stream buffer 25 changes the configuration accordingly. FIG. 12 is a drawing to show a configuration example of the stream buffer 25 for managing data in PCP 111 units. To manage data in the PCP 111 units, the stream buffer 25 provides an untransmitted data storage area 25a, a data-being-transmitted storage area 25b, and a PCP table 25c.

When data is written from the encoder 24, data is written into the untransmitted data storage area 25a, the PCP data size and pointer are written into the PCP table 25c. Accordingly, the location of each PCP 110 area in the untransmitted data storage area 25a can be recognized. Since the PCP 110 is not of fixed length as described above, unless such a table is provided, the location of each PCP 110 cannot be recognized.

The processing flows after data transmission and involved in data transmission resumption after discontinuation of communications shown in FIGS. 7, 8, and 9 are almost similar to those for analog 1ch and therefore will not be discussed again.

As described above, according to the embodiment, when communications are discontinued during the operation, the untransmitted data is stored in the data-being-transmitted storage area 25b and after communications are resumed, the data is transmitted to the PC 10, so that the correct data composition unit (pack or PCP 110) is stored in the buffer 12 in the PC 10. Accordingly, when the decoder 13 of the PC 10 decodes the data, occurrence of an anomaly can be suppressed. Particularly, when the data composition unit is PCP 110, the top position cannot be recognized in PC 10 and thus once the composition unit is lost, there is a possibility that the PC may be unable to decode all later signals. In the embodiment, however, the risk or fear can be removed.

In the embodiment, when a buffer overflow occurs in the stream buffer 25, the data to be discarded is discarded in the pack or PCP units, so that the embodiment also contributes to maintaining the data structure of the transmitted content data.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

In addition, a program for attaining the functions in the embodiments may be recorded in a computer-readable recording medium. In this case, the program recorded in the recording medium is read and executed by a computer system. Incidentally, the “computer system” mentioned here includes an operation system or hardware such as peripheral equipment.

In addition, the “computer system” includes a homepage providing environment (or display environment) when it uses a WWW system.

On the other hand, the “computer-readable recording medium” means a portable medium such as a flexible disk, a magneto-optical disk, a ROM or a CD-ROM, or a storage unit such as a hard disk included in the computer system. Further the “computer-readable recording medium” includes a medium for holding the program for a predetermined time, such as a volatile memory (RAM) in a computer system as a server or a client when the program is transmitted through a network such as the Internet or a communication circuit such as a telephone circuit.

In addition, the program may be transmitted from a computer system storing the program in a storage unit or the like to another computer system through a transmission medium or by a transmitted wave in the transmission medium. Here, the “transmission medium” for transmitting the program means a medium having a function of transmitting information, including a network (communication circuit) such as the Internet or a communication circuit (communication line) such as a phone line.

In addition, the program may be prepared for attaining a part of the aforementioned functions. Further, the program may be a so-called difference file (difference program) which can attain the aforementioned functions in combination with a program which has been already recorded in the computer system.

Further, these modifications may be used selectively and suitably in combination.

The invention is not limited to the foregoing embodiments but various changes and modifications of its components may be made without departing from the scope of the present invention. Also, the components disclosed in the embodiments may be assembled in any combination for embodying the invention. For example, some of the components may be omitted from all the components disclosed in the embodiments. Further, components in different embodiments may be appropriately combined.

What is claimed is:

1. A data transmitter for executing stream-type data transmission of stream data having a predetermined data composition unit to a data receiver, the data transmitter comprising:
a data supply section that supplies the stream data;
a buffer for temporarily storing the stream data supplied from the data supply section; and
a communication section for reading the stream data stored in the buffer and transmitting the data to the data receiver,
wherein when a data amount of the stream data supplied from the data supply section exceeds an available capacity of the buffer, the buffer retains at least untransmitted data that has not been transmitted from the communication section, of the data in the predetermined data composition unit of the data stream being transmitted from the communication section until the untransmitted data is transmitted from the communication section.

2. The data transmitter according to claim 1, wherein when resuming transmission after interrupting transmission of the stream data to the data receiver, the communication section transmits the untransmitted data stored in the buffer to the data receiver.

3. The data transmitter according to claim 2, wherein when the data amount of the stored stream data exceeds the available capacity of the buffer, the buffer discards the stream data in the predetermined data composition unit.

4. The data transmitter according to claim 1, further comprising a data composition unit determination section that determines the data composition unit based on the type of stream data.

5. The data transmitter according to claim 1, wherein the type of stream data is DTCP-IP, and
the predetermined data composition unit is PCP defined in the DTCP-IP.

6. The data transmitter as claimed in claim 1, wherein the stream data supplied from the data supply section is video data received from a TV tuner.

7. A program product for causing a data transmitter to execute stream-type data transmission of stream data having a predetermined data composition unit to a data receiver, the program product enabling a computer to perform functions comprising:
a data supply function of supplying the stream data;
a buffer function of temporarily storing the stream data supplied by the data supply function; and
a communication function of reading the stream data stored by the buffer function and transmitting the data to the data receiver,
wherein when a data amount of the stream data supplied by the data supply function exceeds an available capacity that the buffer function has, the buffer function retains at least untransmitted data that has not been transmitted by the communication function, of the data in the predetermined data composition unit of the data stream being transmitted by the communication function until the untransmitted data is transmitted by the communication function.

8. A data transmission system for executing stream-type data transmission of stream data having a predetermined data composition unit, the data transmission system comprising:
a data receiver that decodes and reproduces transmitted data;
a data transmitter that comprises:
a data supply section that supplies the stream data;
a buffer for temporarily storing the stream data supplied from the data supply section; and
a communication section for reading the stream data stored in the buffer and transmitting the data to the data receiver,
wherein when a data amount of the stream data supplied from the data supply section exceeds an available capacity of the buffer, the buffer retains at least untransmitted data that has not been transmitted from the communication section, of the data in the predetermined data composition unit of the data stream being transmitted from the communication section until the untransmitted data is transmitted from the communication section.
